(19) United States
(12) Patent Application Publication
(10) Pub. No.: US 2019/0082597 A1
(43) Pub. Date: Mar. 21, 2019

(54) LOUVER POSITION SENSING SYSTEM FOR A SIEVE AND CHAFFER OF A COMBINE HARVESTER

(71) Applicant: HCC, INC., Mendota, IL (US)

(72) Inventor: Jeffrey Harris Maney, Rockford, IL (US)

(21) Appl. No.: 16/102,358

(22) Filed: Aug. 13, 2018

Related U.S. Application Data
(60) Provisional application No. 62/560,030, filed on Sep. 18, 2017.

(51) Int. Cl. A01D 41/127; G01D 5/14; A01F 12/44

(52) U.S. Cl. CPC A01D 41/1276; A01F 12/448; G01D 5/145

(57) ABSTRACT

A louver position sensing system for a sieve and chaffer of a combine harvester. The system provides that at least one sensor is in actual, physical contact with one or more louvers of the sieve and chaffer. More than one sensor can be utilized where multiple sensors are connected to multiple louvers of the sieve. The directly coupled sensing of the rotational position of the louver(s) allows for accurate, on-the-fly adjustment of the louvers in order to maximize the efficiency of operation of the sieve and chaffer. Preferably, the sensing system is configured such that sensed position of the louvers is broadcast on the bus of the combine harvester. As a result, the position information can be used to dynamically adjust the openings between the louvers of the sieve and chaffer to achieve more efficient grain cleaning as the machine and field variables change.

### RELATED APPLICATION (PRIORITY CLAIM)

This application claims the benefit of U.S. Provisional Application Ser. No. 62/560,030, filed Sep. 18, 2017, which is hereby incorporated herein by reference in its entirety.

### BACKGROUND

The present invention generally relates to systems for sensing the rotational position of the louvers of a sieve and chaffer of a combine harvester, and more specifically relates to an improved louver sensing system.

Typically, grain and seed crops are harvested by having a combine harvester detach the grain from unwanted portions of the source plants and other matter, such as rocks and weeds. Specifically, a mixture of detached grain and other vegetation parts (i.e., material other than grain (“MOG”) is carried by a conveyer into the interior of the housing of the combine harvester for processing, to further separate the grain from the MOG. In the course of processing within the combine, the mixed grain and MOG are passed over sieves and chaffers which are agitated (i.e., shaken) and configured to permit the grain to fall, via gravity, through the sieve and chaffer for separation from the MOG.

FIGS. 1 and 2 illustrate portions of a typical sieve and chaffer (i.e., “sieve”) 10. As shown, the sieve 10 comprises a generally rectangular frame 12 and a plurality of overlapping banks of slats or louvers 14. The slats 14 define openings through which the grain falls (i.e., by gravity). Typically, each bank of slats 14 includes two or more slats separated by one or more dividers 16 which are connected to the frame 12. Each bank of slats is mounted end-to-end on a wire 18 which is rotatably mounted to the frame 12. A typical sieve is provided as being a single rectangular frame having one or more overlapping banks of slats.

As shown in FIGS. 1 and 2, a sieve can also include a handle 20 which is connected to an elongated adjustment bar 22 which extends perpendicularly to the louver wires 18 and includes a plurality of longitudinally spaced recesses or apertures for engaging a crank on each wire 18, thereby controlling the angular disposition of the slats 14 and the size of the openings between the banks of slats. By this arrangement, the slats 14 effectively become louvers and can be adjusted, using the handle 20, to any position between fully open and fully closed. The sieve 10 is mechanically supported for reciprocal shifting movement or agitation (i.e., shaking) to cause the grain to separate from the MOG and fall downwardly through the openings between the banks of slats.

By providing that the rotational position of the louvers 14 can be adjusted, it is possible to allow for various crop processing, crop condition variation, and feed rate variation. Because the openings between the louvers 14 can be varied, different size grain can be processed without changing out the sieve and/or chaffer unit itself (i.e., for a similar sieve and chaffer unit having different sized openings between the slats 14).

As shown in FIG. 3, some conventional systems provide a visual louver position indicator 26, which an operator has to view in order to determine the extent to which the louvers 14 are open. As shown, such systems provide indicia 28 on the sieve divider 16 and an associated indicating arm 30. As the handle 20 (see FIGS. 1 and 2) is adjusted, the arm 30 changes its position (i.e., moves) relative to the indicia 28. The position of the arm 30 relative to the indicia 28 provides the operator with a visual indication of the extent to which the louvers 14 are open.

Other systems provide that the rotational position of the louvers is determined via an electromechanical actuator position system. Conventional louver position sensing relies on the translation of a linear ball-screw actuator equipped with a simple potentiometer to report the linear position of the actuator. This system is inaccurate for a plurality of reasons, such as: backlash associated with the actuator, resolution of the potentiometer, translation of the position of the ball screw through multiple linkages, distortion of the louver in its position due to loading, etc. These system inaccuracies do not allow for accurate feedback, and thus cause inaccurate position settings resulting in poor dynamic grain cleaning efficiency.

In general, combine harvesters are progressing more and more toward autonomous operation and will require more accurate feedback systems than is currently available in order to enable on-the-fly sieve/chaffer adjustments.

### SUMMARY

An object of an embodiment of the present invention is to provide an improved louver position sensing system for a sieve and chaffer used in a combine harvester.

Briefly, an embodiment of the present invention provides a louver position sensing system for a sieve and chaffer of a combine harvester. The system provides that at least one sensor is in actual, physical contact with one or more louvers of the sieve and chaffer. Preferably, the sensor comprises a hall-effect sensor which provides that a sensor probe extends from a housing and is physically connected to one of the louvers. More than one sensor can be utilized where multiple sensors are connected to multiple louvers of the sieve. Regardless, preferably the accuracy of the sensing of the rotational position of the louver(s) allows for accurate, on-the-fly adjustment of the rotational position of the louvers in order to maximize the efficiency of operation of the sieve and/or chaffer.

Preferably, the sensing system is configured such that sensed position of the louvers is broadcast on the Controller Area Network (CAN) bus of the combine harvester. As a result, the position information can be used to dynamically adjust the openings between the louvers of the sieve and chaffer to achieve more efficient grain cleaning as the machine and field variables change. Alternatively, the system can be configured such that the operator can perform the adjustment, either electronically or manually, after being informed of the rotational position of the louvers by the system. Regardless, incorporating a directly coupled sensor at the louver and utilizing the actuator feedback system, a closed loop control system can be created to autonomously adjust the openings of the louvers of the sieve and chaffer on-the-fly based on specific control parameters within the host control of the combine harvester.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a top view of a standard sieve and/or chaffer construction;

FIG. 2 provides a perspective view of the sieve/chaffer shown in FIG. 1, omitted parts of the frame so other components can be more easily seen;

FIG. 3 illustrates a conventional visual louver position indicator;

FIG. 4 shows a sensor mounted to a divider of a sieve and chaffer, in accordance with one embodiment of the present invention;

FIG. 5 is a side view of the sensor mounting arrangement shown in FIG. 4 (omitting two sieve louvers for clarity);

FIG. 6 is a bottom view of the sensor mounting arrangement shown in FIGS. 4 and 5;

FIG. 7 provides a simplified view of the inside of the sensor shown in FIGS. 4-6;

FIG. 8 is similar to FIG. 6, but provides an exploded view; and

FIG. 9 illustrates one possibility of a system architecture with which the sensor shown in FIGS. 4-8 can be employed.

### DESCRIPTION OF AN ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

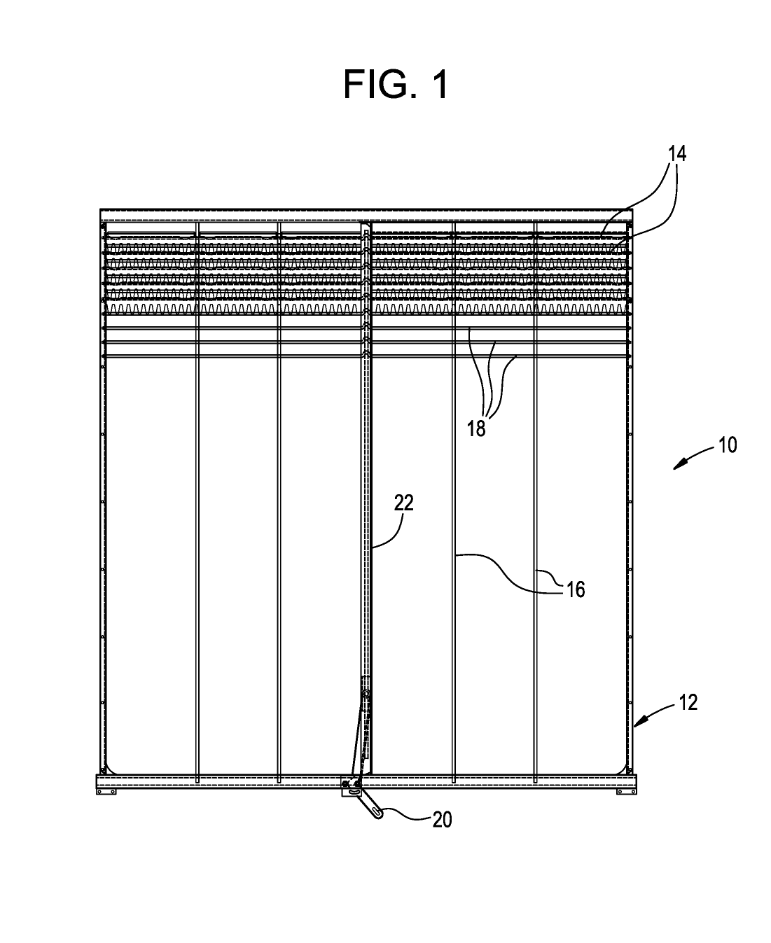

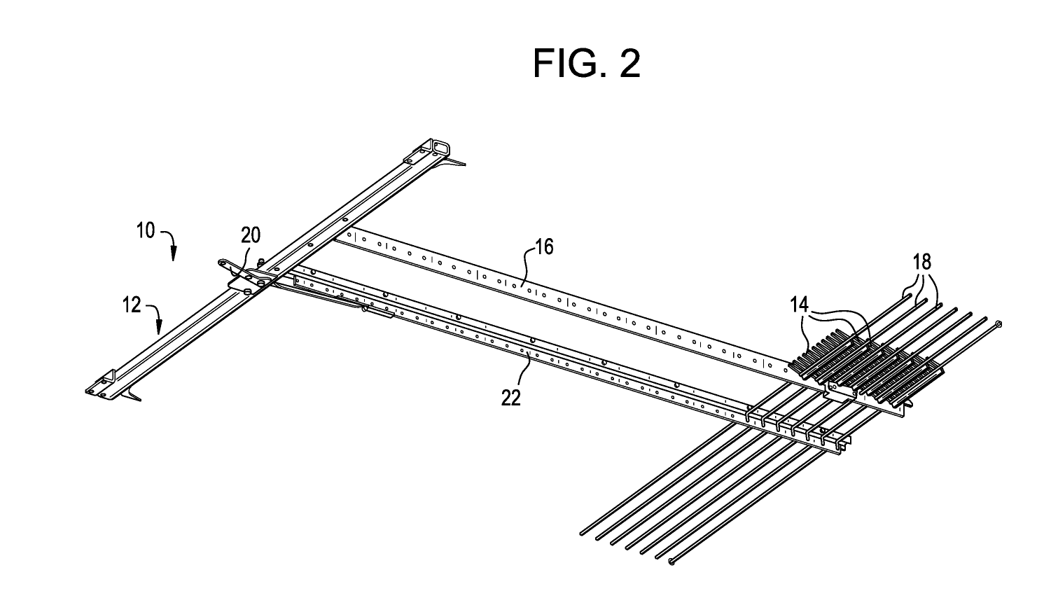

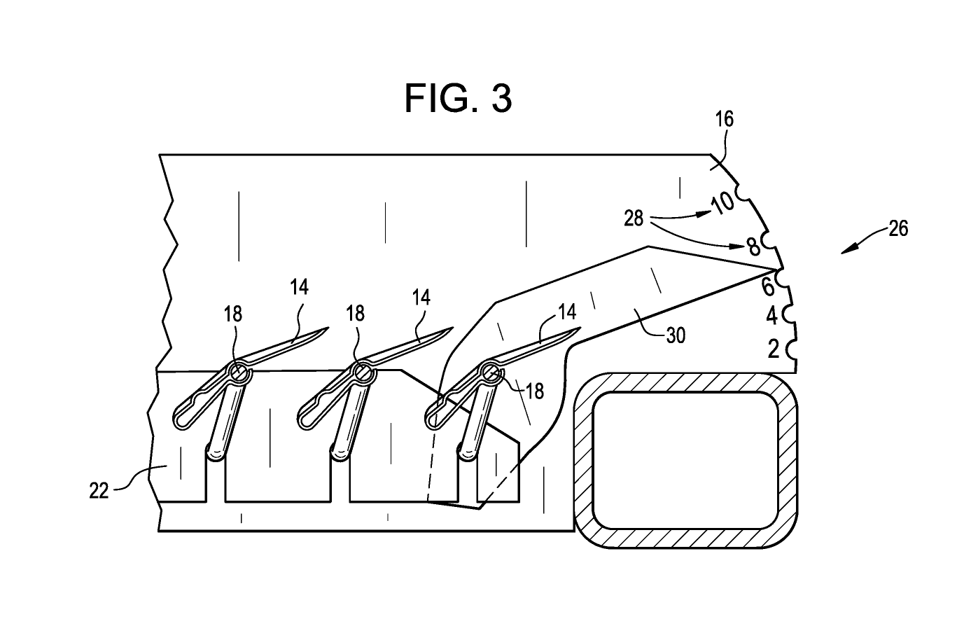

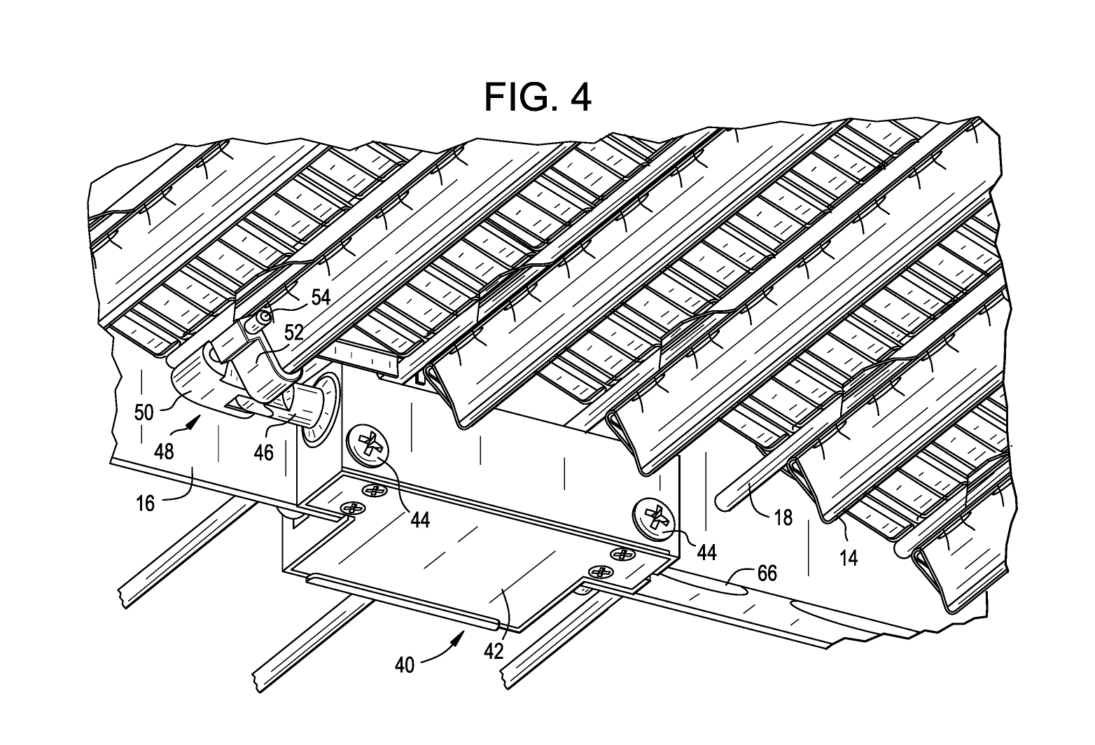

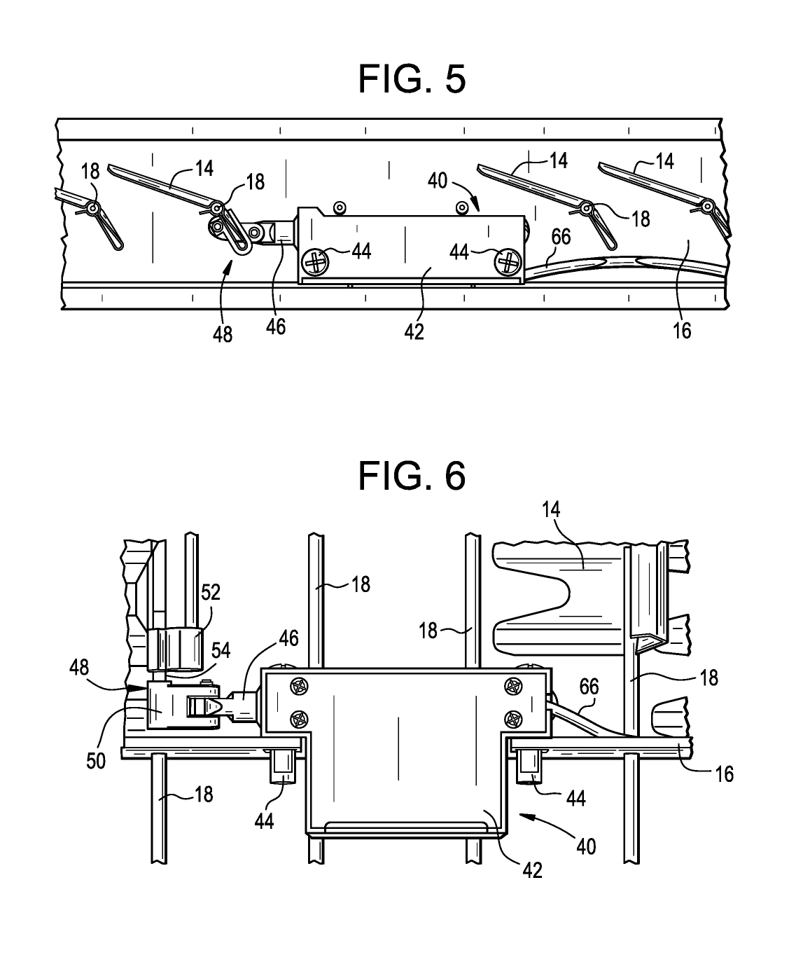

An embodiment of the present invention provides a louver position sensing system for a sieve and chaffer of a combine harvester. The system provides that at least one sensor is in actual, physical contact with one or more louvers of the sieve and/or chaffer. As shown in FIGS. 4-6, the sensor 40 is preferably mounted to one of the dividers 16 of the sieve and chaffer 10 (see FIGS. 1 and 2). Preferably, the sensor 40 comprises a housing 42 which is mounted to the divider 16 via one or more fasteners 44 (or via other means), and a sensor probe 46 extends from the housing 42 and is actually, physically connected to one of the louvers 14 via a sensor coupling 48. As shown in FIGS. 4 and 6, the sensor coupling 48 may comprise a first component 50 connected to the end of the sensor probe 46, a second component 52 connected to a windvane of one of the sieve louvers 14, and a connecting member 54 (such as a pin) which links the first component 50 to the second component 52. Of course, other sensor coupling configurations can be used to connect the sensor probe 46 to the louver 14.

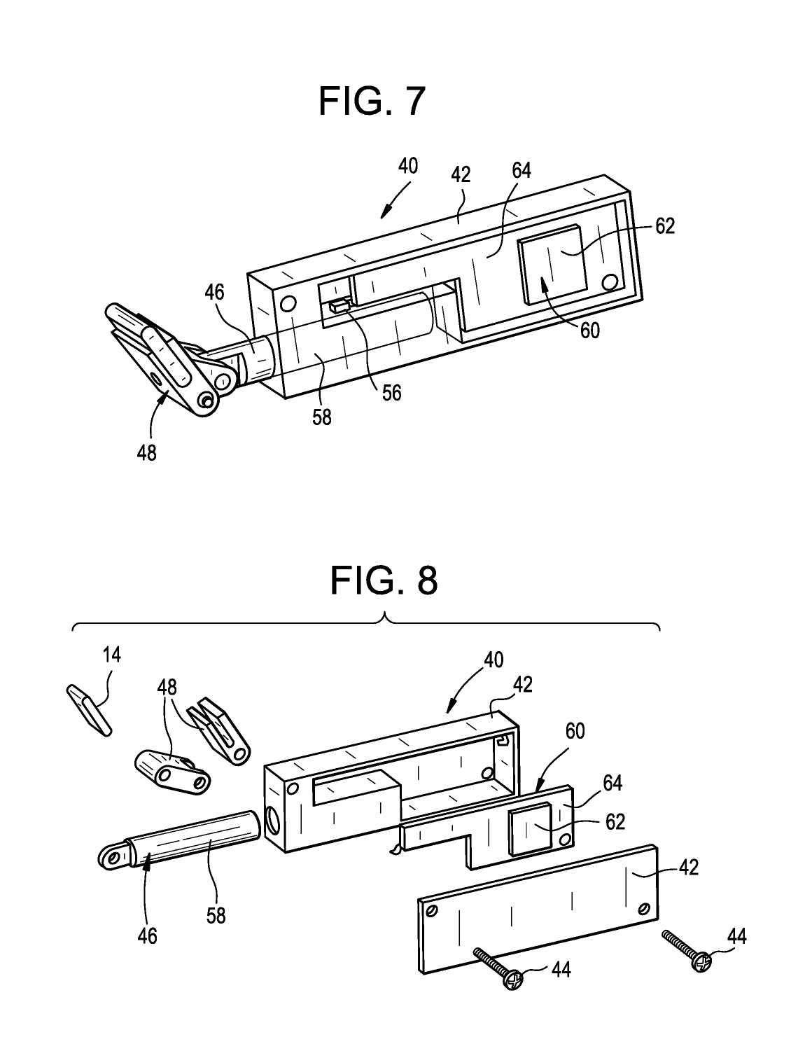

FIGS. 7 and 8 show inside the sensor housing 42. As shown, a hall effect sensor 56 is preferably inside the housing 42 for effectively sensing a cylindrical magnet 58 secured within the sensor probe 46. Preferably, the probe 46 is manufactured from a non-magnetic material and is free to travel linearly within the sensor housing 42. The hall effect sensor 56, via the magnet 58, senses the linear position of the sensor probe 46 and, as a result, the rotational position of the louver 14 to which the sensor probe 46 is connected via the sensor coupling 48. As the louver 14 is opened and closed via an adjustment system, such as an electromechanical motor or some other means, the coupling system translates the louver rotation to linear motion. This linear motion displaces the probe 46 within the sensor housing 42. The hall effect sensor 56 senses the position of the magnet 58 housed within the probe 46.

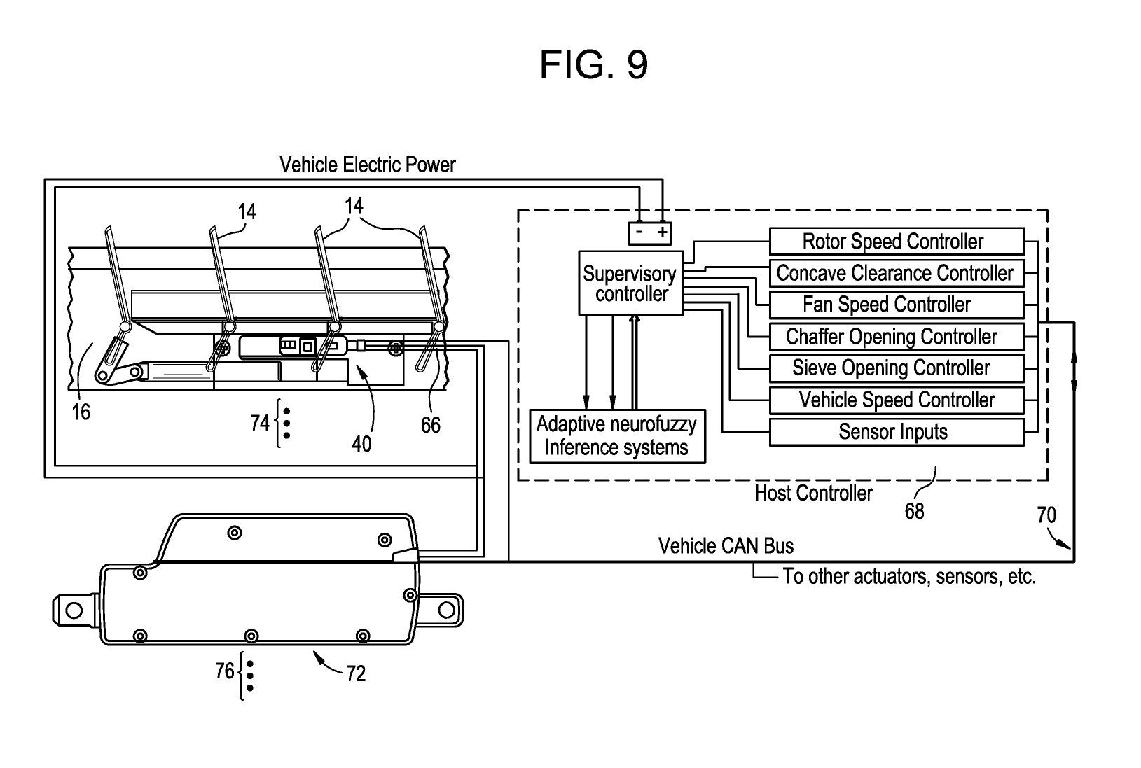

Electronics 60 are also provided inside the housing 42, such as one or more integrated circuits 62 on a printed circuit board 64, which are connected to the hall effect sensor 56, for determining the rotational position of the louver 14, via the hall effect sensor 56. A cable 66 extends from the housing 42 and, as shown in FIG. 9, effectively communicates the position of the louver 14 (e.g., the linear position of the sensor probe 46) back to a host controller 68 of the combine harvester via the vehicle CAN bus 70. The electronics 60 within the sensor housing 42 is configured to translate the probe's linear motion into an output suitable to be interpreted by the host controller 68. This output can be expressed in a number of ways (i.e., change in distance between louver “teeth”, angle, mVdv, etc.) and can be broadcast to the CAN bus 70 of the combine harvester or transmitted directly to a controller of the combine harvester. The electronics 60 provided inside the sensor housing 42 may include additional sensors integrated onto the printed circuit board 64, such as one or more accelerometers, temperature sensors, moisture sensors, wireless transmitters, etc., thereby allowing additional functionality of the overall sensor output to the host controller 68 of the combine harvester.

As shown in FIG. 9, a sieve linear actuator 72 can also be connected to the bus 70 (as well as to an adjustment bar 22 (see FIGS. 1 and 2) of the sieve and chaffer 10). In fact, more than one sensor 40 can be connected to the bus (as represented by dots 74) and more than one sieve linear actuator 72 can be connected to the bus (as represented by dots 76). Because sieves and chaffers are loaded differently depending on their position within the cleaning shoe of the combine harvester, an embodiment of the present invention provides that multiple sensors are connected to each sieve and chaffer to allow for accurate sieve and chaffer opening measurements while crop loading differs across the sieve and chaffer. Additionally, because some sieves and chaffers have multiple adjustments means (i.e., multiple adjustment bars), preferably each adjustable area of the sieve and chaffer utilizes an independent sensor, thereby allowing for more precise differential opening opportunities. In other words, the different sections of a single sieve and chaffer can have different sized louver openings, detected by different sensors and changed using different linear actuators, all part of the same system.

While a specific embodiment of the invention has been shown and described, it is envisioned that those skilled in the art may devise various modifications without departing from the spirit and scope of the present invention.

What is claimed is:

1. A louver position sensing system for a sieve and chaffer of a combine harvester, said sieve and chaffer comprising at least one louver, said louver position sensing system comprising at least one sensor which is in actual, physical contact with said at least one louver.

2. A louver position sensing system as recited in claim 1, wherein the sieve and chaffer comprises at least one divider, and wherein said at least one sensor is mounted to said at least one divider.

3. A louver position sensing system as recited in claim 2, wherein the at least one sensor comprises a housing which is mounted to at least one divider.

4. A louver position sensing system as recited in claim 3, wherein the at least one sensor comprises a sensor probe which extends from the housing, and wherein the sensor probe is actually, physically connected to said at least one louver.

5. A louver position sensing system as recited in claim 4, wherein the sensor probe is actually, physically connected to said at least one louver via a sensor coupling.

6. A louver position sensing system as recited in claim 5, wherein the sensor probe comprises an end, wherein said at least one louver comprises a windvane, wherein the sensor coupling comprises a first component connected to the end of the sensor probe, a second component connected to the windvane, and a connecting member which links the first component to the second component.

7. A louver position sensing system as recited in claim 1, wherein the at least one sensor comprises a housing and a sensor probe which extends from the housing, wherein the at least one sensor comprises a hall effect sensor which is inside the housing and which is configured to sense a magnet which is in the sensor probe.

8. A louver position sensing system as recited in claim 7, wherein the sensor probe comprises a non-magnetic material and is configured to travel linearly within the housing.

9. A louver position sensing system as recited in claim 7, wherein the sensor probe is actually, physically connected to said at least one louver via a sensor coupling, wherein the hall effect sensor, via the magnet, senses a linear position of the sensor probe and, as a result, a rotational position of the at least one louver to which the sensor probe is connected via the sensor coupling.

10. A louver position sensing system as recited in claim 9, wherein the system is configured such that, as the at least one louver opens and closes, the system translates rotation of the at least one louver to linear motion, wherein the linear motion displaces the sensor probe within the sensor housing, wherein the hall effect sensor senses a position of the magnet in the sensor probe.

11. A louver position sensing system as recited in claim 10, further comprising electronics inside the housing, connected to the hall effect sensor, and configured for determining a rotational position of the at least one louver, via the hall effect sensor.

12. A louver position sensing system as recited in claim 11, further comprising appropriate electronics, wherein a cable extends from the housing and communicates a position of at least one louver back to the vehicle host controller.

13. A louver position sensing system as recited in claim 12, wherein the electronics in the housing is configured to translate linear motion of the sensor probe into an output suitable to be interpreted by the vehicle host controller.

14. A louver position sensing system as recited in claim 13, wherein the output is either broadcast to a CAN bus of the combine harvester or transmitted directly to a controller of the combine harvester.

15. A louver position sensing system as recited in claim 14, further comprising at least one sieve linear actuator that is connected to the bus and at least one adjustment bar of the sieve and chaffer.

16. A louver position sensing system as recited in claim 14, wherein a plurality of sensors and sieve linear actuators are connected to the bus, wherein multiple sensors are connected to each sieve and chaffer, and wherein each adjustable area of the sieve and chaffer utilizes an independent sensor.
